(19) United States
(12) Patent Application Publication
(10) Pub. No.: US 2022/0005142 A1
(43) Pub. Date: Jan. 6, 2022

(54) DEVICES, SYSTEMS, AND METHODS FOR COORDINATED EVACUATION OF A PLURALITY OF BUILDINGS

(71) Applicant: MOTOROLA SOLUTIONS, INC., Chicago, IL (US)

(72) Inventors: Bartosz MROZEK, Krakow (PL); Robert ORZECHOWSKI, Krakow (PL)

(21) Appl. No.: 17/292,680

(22) PCT Filed: Nov. 30, 2018
(86) PCT No.: PCT/PL2018/050060

§ 371 Date: May 10, 2021

(51) Int. Cl. G06Q 90/00; G06Q 50/26; H04W 84/12

(52) U.S. Cl. CPC G06Q 90/205; H04W 84/12; G06Q 50/265

(57) ABSTRACT

The states of multiple buildings are shared via a computer network. State information may include current occupancy and exit location. An electronic representation of a coordinated evacuation plan is generated for the buildings based on the shared state. Generation of the coordinated evacuation plan includes selecting an evacuation zone to receive building occupants. The coordinated evacuation plan is electronically transmitted to an electronic device of a building occupant to facilitate evacuation of the buildings during an incident.

### BACKGROUND OF THE INVENTION

During an emergency incident, such as a fire, leakage of a noxious substance, terrorism, severe weather, or a plane crash, it may be required to evacuate occupants of buildings affected by the incident.

Existing systems fail to effectively coordinate evacuation of multiple buildings at the same time. When coordination is not effective, a risk to safety beyond the incident itself may result, such as congestion of transportation systems, uncontrolled crowds, and unnecessary panic.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system to facilitate coordinated evacuation of a building according to an embodiment of the present disclosure.

FIG. 2 is a flowchart of a method to facilitate coordinated evacuation of a building according to an embodiment of the present disclosure.

FIG. 3 is a flowchart of a method to facilitate negotiation of a coordinated evacuation plan of a plurality of buildings according to an embodiment of the present disclosure.

FIG. 4 is a flowchart of a method to facilitate negotiation of a coordinated evacuation plan of a plurality of buildings according to another embodiment of the present disclosure.

FIG. 5 is a block diagram of a system to facilitate coordinated evacuation of a building according to another embodiment of the present disclosure.

FIG. 6 is a block diagram of a data structure of a coordinated evacuation plan of a plurality of buildings according to an embodiment of the present disclosure.

FIG. 7A is a schematic diagram of an example uncoordinated evacuation.

FIG. 7B is a schematic diagram of an example coordinated evacuation according to an embodiment of the present disclosure.

### DETAILED DESCRIPTION OF THE INVENTION

The present disclosure provides devices, systems, methods, and other techniques to coordinate evacuation of a plurality of buildings, so that response to an emergency incident affecting one or more of the buildings may be made more efficient and safer. As will be described in detail below, a building may be provided with a device that generates a coordinated evacuation plan for the building and any number of nearby buildings based on state of the building(s). The building may then communicate the coordinated evacuation plan to other buildings, occupants of the buildings, and emergency services. Each building may generate their own evacuation plans and negotiate with one another to arrive at a coordinated evacuation plan. As such, evacuation may be made more orderly and less likely to prolong or compound the risk presented by the initial incident. Numerous other aspects will also be described.

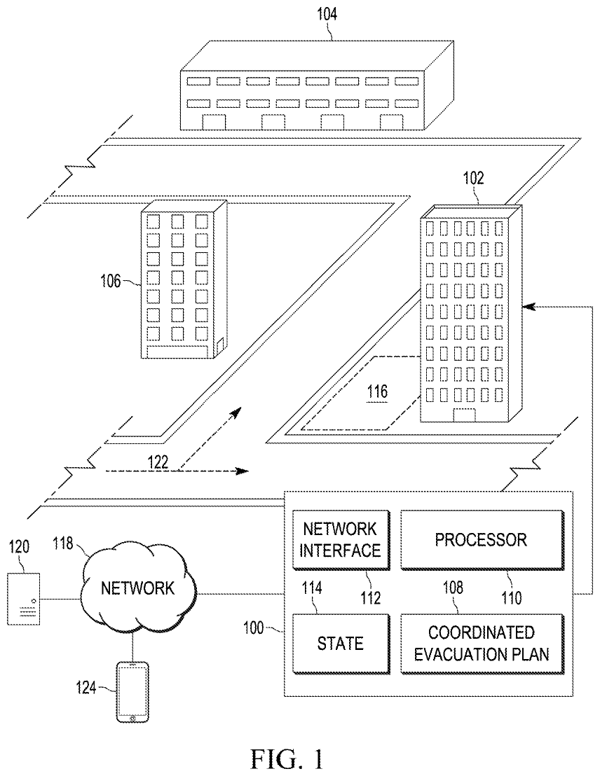

FIG. 1 shows a device 100 deployed at a building 102 located among other proximate buildings 104, 106. The device 100 is configured to generate a coordinated evacuation plan 108 for the building 102 and any of the other buildings 104, 106. Any of the buildings 102-106 may include a such device 100. In another embodiment, a device 100 may be located distant from the buildings 102-106. Such a device 100 may communicate with the buildings 102-106 and centrally coordinate various operations in a server-based or cloud architecture. That is, the generation and dissemination of a coordinated evacuation plan 108 may be distributed (as discussed below), may be centralized, or may take a combined approach (e.g., a central server that coordinates distributed devices). The specific architecture chosen are not particularly limiting.

The device 100 includes an electronic processor 110 and a network interface 112 connected to the processor 110. A representation of the coordinated evacuation plan 108 may be stored in a machine-readable medium (e.g., a memory) accessible to the processor 110. The coordinated evacuation plan 108 may be generated based on state 114 of the building 102, such as its current occupancy, available exit locations, and similar information relevant to the movement of people out of the building. Other state information that may be considered includes a construction material of the building 102, a height of the building 102, a status of evacuation equipment at the building 102, a historic evacuation time of the building 102, and a weather condition. Some state information is static (e.g., building height), while some state information may change as an incident occurs and, as such, the coordinated evacuation plan 108 may be updated to take such changes into account.

The coordinated evacuation plan 108 may identify an evacuation zone 116 outside the building 102 to receive occupants of the building 102 during an incident. Any number of evacuation zone 116 may be used. A representation of the coordinated evacuation plan 108 may be communicated to occupants of any building 102-106 involved in an incident, emergency services, a local authority, a transportation service, and similar entities that may be affected by the incident or may be able to provide assistance to occupants of the buildings 102-106.

The processor 110 may include a central processing unit (CPU), a microcontroller, a microprocessor, a processing core, a field-programmable gate array (FPGA), or a similar device capable of executing instructions. The processor 110 may cooperate with a non-transitory machine-readable medium that may be an electronic, magnetic, optical, or other physical storage device that encodes executable instructions. The machine-readable medium may include, for example, random access memory (RAM), read-only memory (ROM), electrically-erasable programmable read-only memory (EEPROM), flash memory, a storage drive, an optical disc, and/or similar.

The processor 110 may be configured to determine whether evacuation of the building that contains the device 100 is necessary based on information, such as the location of the incident relative to the building, a probability of the incident affecting the building, and similar. If evacuation is not needed, then the processor 110 may periodically redetermine whether evacuation is necessary as the incident progresses. A building that is unaffected by the incident may still contribute to a coordinated evacuation plan by indicating that no evacuation is needed.

The processor 110 may be configured to generate the coordinated evacuation plan 108 based on the state of the building 102 and further based on the state of any number of nearby buildings 104, 106 and a state of any number of evacuation zones 116. State may be determined by a device located at a building/zone and may be measured by sensor at such building/zone. The processor 110 may be configured to generate the coordinated evacuation plan 108 in response to detection of an incident that requires evacuation. Alternatively, the processor 110 may be configured to generate the coordinated evacuation plan 108 continually, so that a current evacuation plan is readily available when an incident occurs.

For any building that is not equipped to monitor its own state or communicate with a device 100, a proxy building may be assigned. The proxy building includes a device 100 and may store information about the unequipped building, such as occupancy and exit locations. Hence, when a coordinated evacuation plan is generated, the proxy building may provide relevant state for an unequipped building. If no suitable sensor is available at the unequipped building, then its state may be static or estimated. For example, a proxy building may store an expected occupancy of an unequipped building based on time of day, day of week, etc. In another embodiment, a central device 100 stores information about unequipped buildings.

The network interface 112 may be configured to communicate via a computer network 118, such as a wired computer network, a wireless computer network, or a combination of such. Examples of suitable computer networks 118 include an intranet, local-area network (LAN), a wide-area network (WAN), the internet, a cellular network, and similar.

The processor 110 may be configured to generate the coordinated evacuation plan 108 based on information received via the network interface, such as information concerning the incident from an authority or emergency service. A remote server 120 may provide such information to the device 100 via the computer network 118.

The processor 110 may be configured to generate the coordinated evacuation plan 108 based on preferred access routes 122 used by emergency services. Information on such access routes may be preprogrammed into the device 100 or may be obtained from a remote server 120 associated with an emergency service. A preferred access route 122 for an emergency service may be an input to the generation of the coordinated evacuation plan 108. An access route 122 for an emergency service may be a generated output provided with the coordinated evacuation plan 108. That is, the incident and its evacuation may require changes to emergency services access routes.

The processor 110 may be configured to use a trained machine learning process to generate the coordinated evacuation plan. A machine learning process may be trained using data collected at various buildings 102-106 during actual or simulated incidents, data collected during evacuation drills, data from historic incidents, or data from similar sources.

The processor 110 may be configured to use a suitable pathfinding algorithm with reference to an electronic map of the area containing the buildings 102-106. Evacuation routes and routes for emergency services may be constrained to avoid intersection and counterflow where possible. Routing priority for a building may be assigned based on nearness to an incident or probability of affect by the incident. Routing priority for an evacuation zone may be based on distance from the incident, capacity, and relative safety. Evacuation routes and evacuation zones are selected based on building occupancy, as routes and zones should be selected to accommodate the determined number of evacuees. Evacuation routes and evacuation zones may also be selected based on building exit location, so that evacuees are efficiently conveyed away from the incident.

The network interface 112 is configured to communicate with respective devices 100 that may be deployed at other buildings 104, 106. Communication among devices 100 allows for the coordinated evacuation plan 108 to be generated based on differing states of different buildings 102-106 and further allows for negotiation among buildings 102-106 and updating of the coordinated evacuation plan 108 as an incident and its evacuation evolves over time. The coordinated evacuation plan 108 may be structured to prioritize evacuation of a building 102-106, particularly of a building 102-106 directly affected by an incident. Priority may be decreased for buildings further away from the incident or for buildings that are less likely to be affected by the incident.

The processor 110 may be configured to cause a representation of a coordinated evacuation plan 108 to be transmitted to any number of electronic devices 124, such a device operated by user of a building 102-106. An example of such a device is a smartphone, tablet computer, notebook computer, or similar device that may be in the possession of a building occupant. The occupant may be a regular user of the building or a specialized individual, such as a fire warden, floor warden, a superintendent, a security guard, or similar

Similarly, the processor 110 may be configured to cause a representation of a coordinated evacuation plan 108 to be transmitted to a computer device operated by an emergency service, such as a vehicle-installed computer of a fire service, a paramedic service, a police service, a handheld device or smartphone carried by a member of such a service, or similar Further, the processor 110 may be configured to cause a representation of a coordinated evacuation plan 108 to be transmitted to a remote server 120 of an authority or emergency service responsible for or assisting with management of the incident.

Similarly, the processor 110 may be configured to cause a representation of a coordinated evacuation plan 108 to be transmitted to a computer device or server 120 operated by a public or private transportation service, such as a subway service, bus service, traffic authority, or similar. For example, it may be desirable to reroute transportation vehicles to avoid or assist with an incident. Further, traffic lights may be controlled in response to the coordinated evacuation plan 108, so as to provide more efficient access to the incident by emergency services.

The processor 110 may be configured to broadcast the electronic representation of the coordinated evacuation plan 108 to any number of nearby buildings 104-106, devices 124, and servers 120. Broadcast may be achieved by a broadcast-capable network communications protocol, radio, or similar.

The coordinated evacuation plan 108 may be provided to a device via a short message service (SMS) message, a multimedia message service (MMS) message, an email message, an application programming interface (API) message, or similar. The representation of the coordinated evacuation plan 108 may include an identification of a building exit for use during evacuation, an identification of an evacuation zone, directions of an evacuation route, directions of an emergency service access route, a map, a link to any such information, or similar.

The processor 110 may be configured by, for example, executable instructions, to implement the functionality, methods, and/or processes described herein.

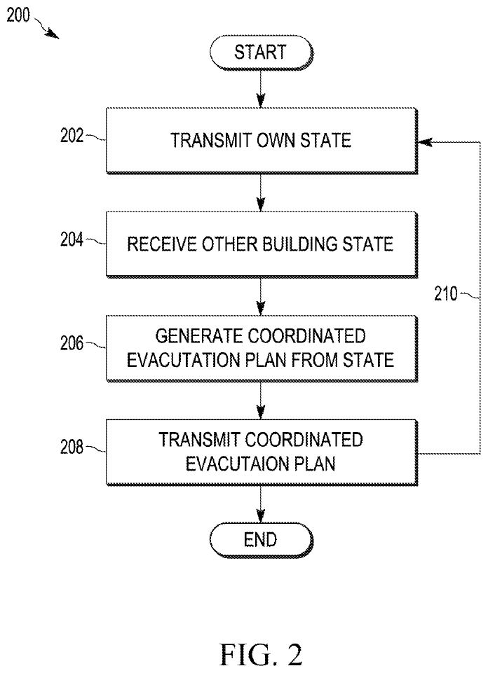

FIG. 2 shows a method 200 to generate and disseminate a coordinated evacuation plan. The processor 110 may be configured to perform the method 200.

The method 200 may be initiated by in response to detection of an incident that requires evacuation. That is, a device installed at a building may detect an incident via, for example, a fire alarm, a security alarm, a door sensor, an incoming message, or similar. In response, device may trigger the method 200 to generate a coordinated evacuation plan at the time it is needed.

Alternatively, the method 200 may be continually performed, irrespective of any incident that requires evacuation, so that a current coordinated evacuation plan is readily available when needed. That is, the coordinated evacuation plan may be continually pre-generated, so that it is ready at the moment an incident is detected.

At block 202, first state of a first building, such the building 102 of FIG. 1, is transmitted, via a network interface at the first building 102, to a proximate second building, such as the building 106.

The first state includes an electronic representation of a current occupancy of the first building 102 and a location of an exit of the first building 102. The current occupancy may be a measured or approximated occupancy determined by a sensor located at the first building 102.

At block 204, the first building 102 receives, via its network interface, second state of the proximate second building 106.

The second state may contain a type of information similar to the first state, such an electronic representation of a current occupancy of the second building 106 and a location of an exit of the second building 106. In addition or alternatively, the second state may contain a different type of information.

If the second building 106 is not provided with a device capable of obtaining or transmitting the state of the second building 106, then block 204 may be performed by the device at the first building 102 obtaining information about the second building 106 from another source, such as a memory of the device at the first building 102, a server, or similar data source. As such, the method 200 may be used for buildings that are not equipped with suitable devices. A building that includes a capable device, a server, or another data source may act as a proxy for an unequipped building.

At block 206, an electronic representation of a coordinated evacuation plan 108 for one or both of the first building 102 and the second building 106 is generated. The coordinated evacuation plan 108 may be generated by a processor, such as a processor 110 located at the first building 102. The coordinated evacuation plan 108 is generated as based on the first state and the second state of the respective buildings 102, 106. That is, the coordinated evacuation plan 108 takes into account the number of people in each building 102, 106 and the locations of the exits of the buildings 102, 106.

Generation of the representation of a coordinated evacuation plan 108 includes selecting an evacuation zone 116 outside the buildings 102, 106. The evacuation zone 116 may be selected based on its capacity to receive people and its relative position with respect to building exits. Multiple different evacuation zones 116 may be selected, so that a given zone does not become overcrowded and further so that people are not evacuated to or in the direction of potentially dangerous locations. The coordinated evacuation plan 108 may further include a route for evacuees to follow and a route for emergency services to access the area of the incident.

At block 208, the representation of a coordinated evacuation plan 108 is electronically transmitted to a device for output to the one or more occupants of the first building 102 and/or the second building 106. The representation of a coordinated evacuation plan 108 may additionally be transmitted to a device or server operated by an emergency service, a local authority, a transportation service, or similar.

The method 200 generates a coordinated evacuation plan based on states of two or more buildings. As such, evacuees may be routed to evacuation zones via evacuation routes that do not mutually interfere. Further, emergency services may be routed efficiently as well. For example, the situation where two high-occupancy buildings are evacuated to the same location at the same time may be avoided.

The method 200 may be repeated indefinitely or until the incident is over, via loop 210, so as to continually dynamically generate the electronic representation of the coordinated evacuation plan. The states of the buildings may change over time during the incident and, as such, repeating the method 200 allows for change in building state to be implemented into the coordinated evacuation plan.

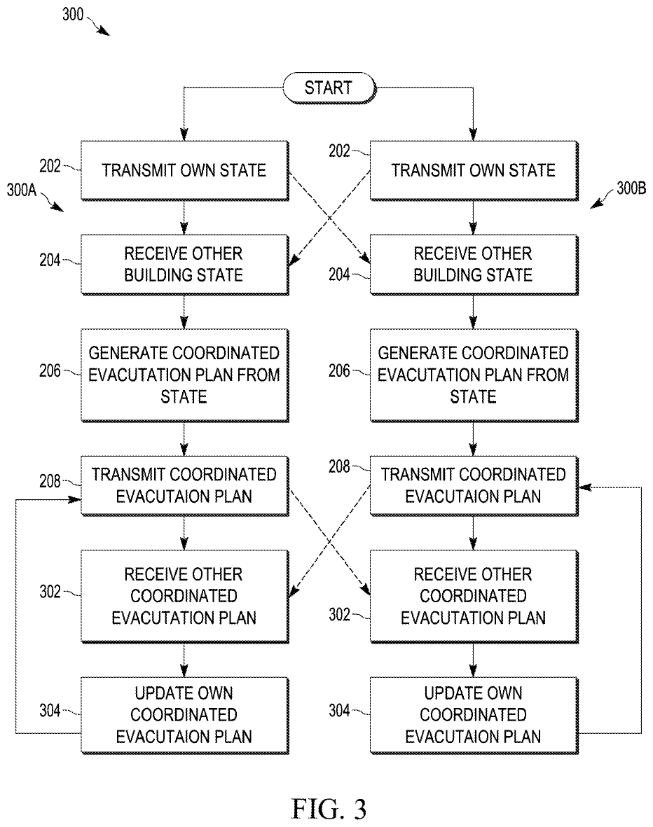

FIG. 3 shows a method 300 for negotiating a coordinated evacuation plan among buildings. The method 300 is similar to the other methods described herein and only differences are described in detail. Description for the blocks described elsewhere herein may be referenced.

A sub-method 300A may be performed by a first device at a first building and another sub-method 300B may be performed by a second device at a second building. The first and second devices may share information via a network.

At blocks 202 and 204, the first and second buildings share their states. At blocks 206, each building generates its own a coordinated evacuation plan. At blocks 208, 302, the proximate first and second buildings share representations of their respective coordinated evacuation plans. Then, at block 304, each building may update its own coordinated evacuation plan based on the coordinated evacuation plan received from another building. That is, for example, the first building may receive a coordinated evacuation plan from a second building and may take the received coordinated evacuation plan to be a request for a change to the first building's own coordinated evacuation plan. The first building may then update its own coordinated evacuation plan based on such information. Blocks 208, 302, 304 may be repeated and until the coordinated evacuation plans of different buildings stabilize or converge. Stabilization may be determined when an update at block 304 does not significantly change a coordinated evacuation plan. Convergence may be determined when multiple coordinated evacuation plans do not differ by a significant degree.

The method 300 may include any number of sub-methods 300A, 300B performed by any number of devices at respective buildings to implement a peer-to-peer negotiation of coordinated evacuation plans. If a building goes offline or a network goes down, each building has at least a partially negotiate evacuation plan and any buildings still able to communicate may continue to negotiate their evacuation plans.

In addition, in block 304, a building may update its own coordinated evacuation plan based on changes in its state, such as changes in available exits. For example, an exit may become unusable as an incident unfolds.

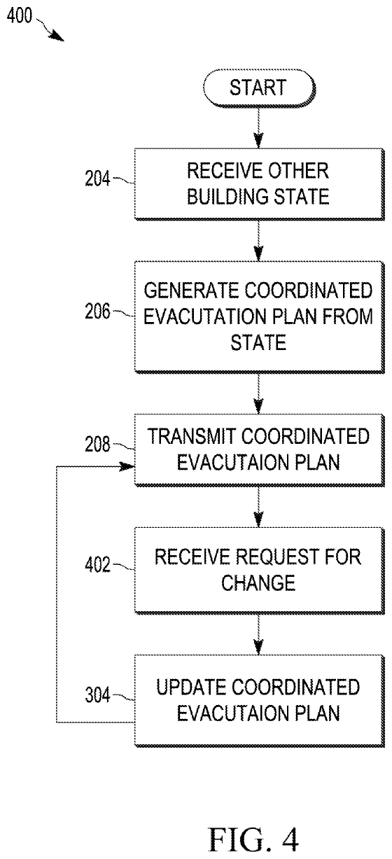

With reference to FIG. 4, a method 400 for negotiating a coordinated evacuation plan among buildings may use one building to maintain a coordinated evacuation plan and may take requests for change from other buildings. The method 400 is similar to the other methods described herein and only differences are described in detail. Description for the blocks described elsewhere herein may be referenced.

A coordinated evacuation plan is generated at device installed at a building, at block 206, based on the building's state and state received from at least one other building, at block 204. A representation of the coordinated evacuation plan is transmitted to the other building, at block 208.

A device installed at the other building receives the coordinated evacuation plan, reviews the coordinated evacuation plan, and determines that a change is required. For example, an evacuation zone selected may be incompatible with a situation of the other building. In another example, the state of the other building may change over time and the coordinated evacuation plan may become unsuitable due to a change of state. A request for change may be transmitted to the building that originated the coordinated evacuation plan.

The originating building receives the request for change, at block 402, and updates the coordinated evacuation plan, at block 304, if such an update is determined to be necessary. The originating building may then transmit a representation of the updated coordinated evacuation plan and further changes may be received and incorporated.

The method 400 allows for a central arbiter for the coordinated evacuation plan, where a device at one building generates and updates the coordinated evacuation plan based on feedback provided by devices at other buildings.

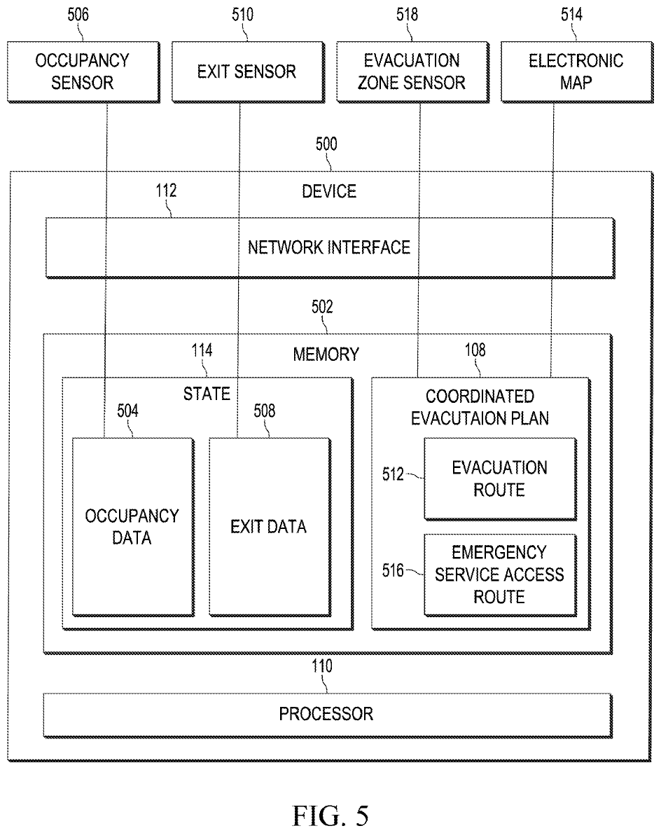

FIG. 5 shows a device 500 that may be deployed at a building to generate a coordinated evacuation plan 108 for the building and any of the other buildings nearby. The device 500 is similar to the other devices described herein and only differences will be described in detail.

The device 599 includes memory 502 to store a coordinated evacuation plan 108 as well as state information 114 for the building at which the device 500 is installed.

State 114 may include occupancy data 504, such as a current occupancy that may be measured or otherwise determined with a sensor 506. Such a sensor 506 may be remote from the device 500 and connected to the device 500 via a network interface 112 or similar interface of the device 500. Examples of sensors 506 include a door sensor to detect when a door threshold has been passed by a person, a security gate sensor, security card scanner, a biometric scanner, a camera, and similar sensors capable of providing information that may be used to keep a running count or approximation of the number of people present in the building.

State 114 may include exit data 508, such as exit locations, exit facings (e.g., North, South, East, West), throughput capacity of exits (e.g., 100 people per minute), exit status, such as available or unavailable depending on the situation at hand, or similar. Some exit data 508, such as physical information about exits, may be pre-programed into the memory 502. For example, in the case that a new exit is constructed, a user may manually update the exit data 508 to reflect this. Other exit data 508, such as whether an exit is currently accessible or not, may be obtained via a sensor 510. For example, a smoke detector may be referenced to determine whether it is safe to use an exit near the smoke detector. Other example sensors 510 that can provide exit data include a heat detector, a camera, a door sensor, or similar.

State 114 may further include other static and dynamic information relevant to building evacuation, such as a construction material of the building, a height of the building, a status of evacuation equipment at the building, a historic evacuation time of the building, and a weather condition. Static information may be pre-programmed into the memory 502, while dynamic information may be obtained through the network interface 112.

The coordinated evacuation plan 108 may include a representation of an evacuation route 512 for the one or more occupants of the building to follow to an evacuation zone outside the building. An evacuation route 512 may identify any number of exits of the building and any number of target evacuation zones outside the building. Other information may be included in the evacuation route 512, such as a path between a building exit and the evacuation zone or similar information. Any number of evacuation routes 512 may be provided.

An evacuation route 512 may be generated based on an electronic map 514 of the building and surrounding area. The electronic map may provide the locations of the building and nearby buildings, locations of evacuation zones, orientations of building exits, roads, preferred or predefined emergency services access routes, and similar information. The electronic map 514 may be stored at the device 500 or communicated to the device 500 via the network interface 112.

The coordinated evacuation plan 108 may include a representation of an emergency service access route 516 for access to the affected area by an emergency service. An emergency service access route 516 may identify any number of roads or other paths. Any number of emergency service access routes 516 may be provided. An emergency service access route 516 may be generated based on the electronic map 514 of the building and surrounding area.

A processor 110 connected to the memory 502 and the network interface 112 may be configured to generate the coordinated evacuation plan 108 based on state 114 of the building and state of any number of other buildings received via the network interface 112. The coordinated evacuation plan 108 may be based on occupancy data 504 of the building, such as its current occupancy, as well as the current occupancy of other buildings. The coordinated evacuation plan 108 may further be based on the electronic map 514 and exit data 508 for the building as well as other buildings. For example, an incident that occurs during office hours may require additional exits and evacuation zones to be used compared to an incident that occurs outside of office hours. The coordinated evacuation plan 108 may be generated to select evacuation zones that distribute people in an efficient manner that reduces risk of overcrowding and exposure to the effects of the incident. For example, it may be that evacuation zones far from the affected building are selected and evacuees from several buildings are distributed evenly to these zones.

The processor 110 may be configured to determine an evacuation route 512, as part of the coordinated evacuation plan 108, for building occupants to follow to an evacuation zone. Just as undue crowding at an evacuation zone is to be avoided, intersecting or convergent evacuation routes may be avoided to reduce the risk of confusion and to reduce the time it takes to reach the evacuation zone. In addition, it may be efficient to avoid routing evacuees in a manner that complicates access by emergency services.

Similarly, the processor 110 may be configured to determine an emergency service access route 516, as part of the coordinated evacuation plan 108, for an emergency service to follow to an affected area, such as an evacuation zone, a building, or so on.

The processor 110 may be configured to dynamically update the coordinated evacuation plan 108 as state of the building and other buildings changes. For example, if a building exit becomes unusable (e.g., inudated with smoke), as determined by an exit sensor 510, then the coordinated evacuation plan 108 may be updated to route evacuees to other exits.

The device 500 may further be connected to a sensor 518 at an evacuation zone. The sensor 518 may capture information about the evacuation zone, where such information may indicate whether the zone is safe, a degree of occupancy, or similar. Examples of such a sensor 518 include a camera, a microphone, and similar.

The processor 110 may be configured to generate and update the electronic representation of the coordinated evacuation plan 108 further based on a state of the evacuation zone, as determined by an evacuation zone sensor 518. For example, the processor may update the coordinated evacuation plan 108 to stop routing evacuees to a zone that has become overcrowded.

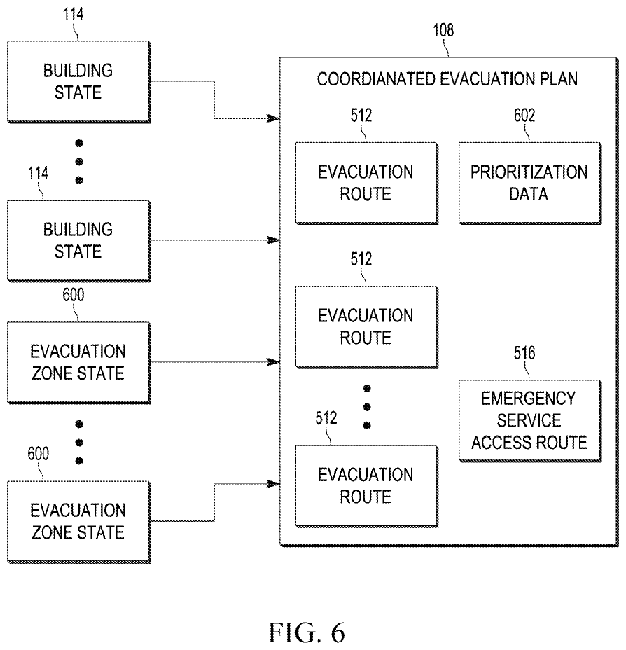

With reference to FIG. 6, a coordinated evacuation plan 108 may be generated and updated based on states 114 of a plurality of buildings affected by an incident. Further, the coordinated evacuation plan 108 may be generated and updated based on states 600 of a plurality of evacuation zones in the vicinity of the buildings.

The coordinated evacuation plan 108 may include a plurality of evacuation routes 512. A given building may be associated with any number of evacuation routes 512.

The coordinated evacuation plan 108 may include a plurality of emergency service access routes 516.

The coordinated evacuation plan 108 may include prioritization data 602. Prioritization data 602 may rank buildings, so that higher priority buildings may be given preferential evacuation zones and routes. A building at which an incident occurs may be given the highest priority. Priority of nearby buildings may be based on their proximity to the building at which an incident occurs or based on a probability that the incident will affect nearby buildings at a later time. Priority may be inversely proportional to distance from the incident. For example, an incident at a first building may require efficient routes to nearby evacuation zones to quickly and safely evacuate occupants of the first building. Nearby second and third buildings may be given reduced priority and evacuation zones for such buildings may be somewhat more distant or follow less direct routes. Priority between the second and third buildings may be determined based on proximity to the first building. For example, if the second building is closer to the first building, then the second building may be determined to have a higher degree of risk and may be given priority evacuation routes and zones over the third building.

Prioritization data 602 may also include temporal information, such as a time to commence evacuation of a building. For example, it may be desirable to delay evacuation of a building that is relatively distant from an incident, so as to reduce the risk that an evacuation zone becomes overcrowded.

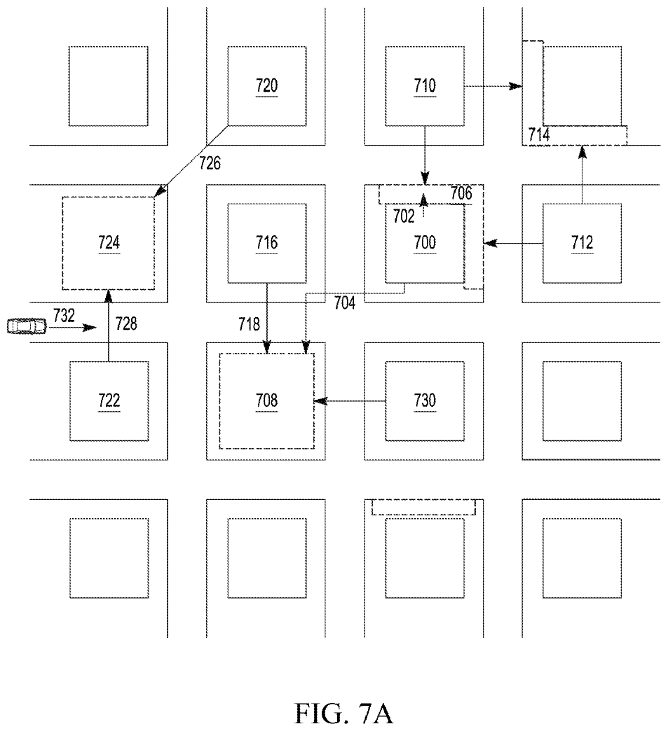

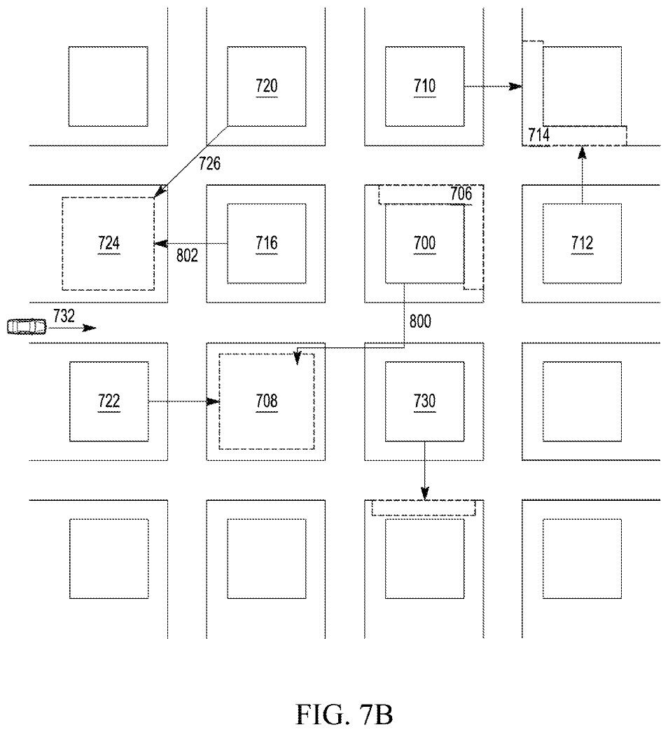

FIGS. 7A and 7B show example scenarios. In FIG. 7A, an incident occurs at a building 700 and each building has an independent evacuation plan. Evacuees from the building 700 take evacuation routes 702, 704 to respective evacuation zones 706, 708. Occupants of a nearby buildings 710, 712 evacuate to zones 706 and 714. Another nearby building 716 has occupants take a route 718 to zone 708. Other buildings 720, 722 in the vicinity evacuate to a zone 724 via respective routes 726, 728. Still another building 730 evacuates to zone 708. However, these independent evacuation plans are uncoordinated and may put evacuees at risk. For example, evacuation zone 708 may become overcrowded due to several buildings evacuating there. Further, routes 728, 718, 704 may cross an access path 732 for emergency services responding to the incident at the building 700. This may delay access to the incident by emergency services and put evacuees at risk.

In FIG. 7B, an incident occurs at a building 700 and a coordinated evacuation plan is generated using the techniques described herein. The building 700 directly affected by the incident is evacuated to evacuation zone 708 via an evacuation route 800 that avoids as much as possible the access path 732 for emergency services. No building is evacuated to evacuation zones 706, as this could put evacuees at risk due to the proximity of zone 706 to the directly affected building 700. Buildings 716, 720 are evacuated to zone 724 by respective routes 802, 726. Notably, route 802 is selected to not interfere with the access path 732 for emergency services and to yield evacuation zone 708 to the evacuees from building 700, which has higher priority due to it being directly affected by the incident. Building 730 also yields the evacuation zone 708 to building 700. Building 722, however, evacuates to zone 708 to avoid interfering with the access path 732 for emergency services.

In view of the above, it should be apparent that a coordinated evacuation plan for a plurality of buildings may be generated and/or negotiated based on building state, so that response to an emergency incident affecting one or more of the buildings may be made more efficient and safer. Evacuation of buildings in response to an incident may be more organized and less likely to increase the risk presented by the initial incident.

Machine learning and other computational processes as discussed herein which may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms, reinforcement learning algorithms, and the like.

However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some public safety environments. However, any suitable machine learning algorithm is within the scope of present disclosure.

A machine learning process may be trained with actual sensor information, such as images or other data representative of a running count of occupants entering and leaving a building, alarms triggered at the building or nearby buildings, or similar.

A machine learning process may be trained with predefined sensor information, such data from a library or from past actual incidents, staged incidents, or evacuation drills.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A device comprising:
an electronic processor; and
a network interface configured to communicate with respective network interfaces deployed at a plurality of buildings, the electronic processor configured to:
transmit, via the network interface, a first state of a first building of the plurality of buildings, the first state including an electronic representation of a current occupancy of the first building and a location of an exit of the first building;
receive, via the network interface, a second state of a second building of the plurality of buildings, the second state including an electronic representation of a current occupancy of the second building and a location of an exit of the second building;
generate an electronic representation of a coordinated evacuation plan for one or more of the first building and the second building based on the first state and the second state, including selecting an evacuation zone outside the first building and the second building to receive one or more occupants of one or more of the first building and the second building; and
electronically transmit the electronic representation of the coordinated evacuation plan to at least one device for output to the one or more occupants of one or more of the first building and the second building.

2. The device of claim 1, wherein the processor is further configured to generate the electronic representation of the coordinated evacuation plan in response to detection of an incident that requires evacuation.

3. The device of claim 1, wherein the processor is further configured to generate the electronic representation of the coordinated evacuation plan continually and dynamically irrespective of any incident that requires evacuation, such that the coordinated evacuation plan is pre-generated when an incident occurs.

4. The device of claim 1, wherein the processor is further configured to determine an evacuation route for the one or more occupants to follow to the evacuation zone, and wherein the processor is configured to include the evacuation route in the coordinated evacuation plan.

5. The device of claim 1, wherein the processor is further configured to:
transmit, via the network interface, the electronic representation of the coordinated evacuation plan to a second device of the second building;
receive, via the network interface, a requested change to the coordinated evacuation plan from the second device; and
update the electronic representation of the coordinated evacuation plan based on the requested change.

6. The device of claim 1, wherein the processor is further configured to measure the current occupancy of the first building using a sensor located at the first building.

7. The device of claim 1, wherein the processor is further configured to generate the electronic representation of the coordinated evacuation plan are further to reference an electronic map of an area that includes the first building and the second building, orientations of the exit of the first building and the exit of the second building, and one or more access paths for an emergency service.

8. The device of claim 1, wherein the processor is further configured to electronically transmit the electronic representation of the coordinated evacuation plan to a computer device of an emergency service.

9. The device of claim 1, wherein the processor is further configured to broadcast the electronic representation of the coordinated evacuation plan to a nearby building.

10. The device of claim 1, wherein the processor is further configured to continually dynamically generate the electronic representation of the coordinated evacuation plan based on the first state and the second state changing over time during an incident that requires evacuation.

11. The device of claim 7, wherein the processor is further configured to continually dynamically generate the electronic representation of the coordinated evacuation plan further based on a state of the evacuation zone outside the first building and the second building, the state of the evacuation zone being determined by a sensor connected to the processor.

12. The device of claim 1, wherein the processor is further configured to generate the electronic representation of the coordinated evacuation plan are further to prioritize evacuation of the first building when an incident that requires evacuation is detected at the first building.

13. The device of claim 1, wherein the processor is further configured to:
determine a third state of a third building of the plurality of buildings, the third state including an electronic representation of a current occupancy of the third building and a location of an exit of the third building; and
generate the electronic representation of the coordinated evacuation plan for the first building, the second building, and the third building, including prioritizing evacuation of the second building and the third building based on proximity to the first building when an incident the required evacuation is detected at the first building.

14. The device of claim 1, wherein the first state further comprises an indication of one or more of: a construction material of the first building, a height of the first building, a status of evacuation equipment at the first building, and a historic evacuation time of the first building.

15. The device of claim 1, wherein to the processor is further configured to generate the electronic representation of the coordinated evacuation plan further with reference to third state of a third building that is not connected to the network interface, the processor configured to obtain the third state from another source.

16. A non-transitory computer-readable medium encoded with instructions to facilitate evacuation of a building, the instructions executable by a processor to:
determine a state of the building, the state of the building including a current occupancy of the building and a location of an exit of the building;
generate an evacuation plan for the building based on the state of the building, including selecting an evacuation zone outside the building to receive occupants the building; and
broadcast the evacuation plan to at least one proximate communications interface of at least one proximate building.

17. The non-transitory computer-readable medium of claim 16, wherein the instructions are further configured to generate the evacuation plan for the building further based on a proximate evacuation plan received from a proximate processor of a proximate building.

18. The non-transitory computer-readable medium of claim 16, wherein the instructions are further configured to negotiate a combined evacuation plan with a proximate processor of a proximate building based on a proximate evacuation plan received from the proximate processor by updating the evacuation plan for the building based on the proximate evacuation plan and by transmitting an updated evacuation plan for the building to the proximate processor.

19. The non-transitory computer-readable medium of claim 18, wherein the instructions are further configured to generate and update the evacuation plan with reference an electronic map of an area that includes the building and the proximate building, orientations of the exit of the building and an exit of the proximate building, and one or more access paths for an emergency service.

20. A method to facilitate evacuation of a building, the method comprising:
storing an electronic map of an area that includes representations of a plurality of buildings, orientations of exits of the of the plurality of buildings, and one or more access paths for an emergency service;
determining a plurality of states of the plurality of buildings, each state including an electronic representation of a current occupancy of a respective building and a location of an exit of the respective building;
generating an electronic representation of a coordinated evacuation plan for the plurality of buildings based on the plurality of states and the electronic map, including selecting an evacuation zone outside the plurality of buildings to receive occupants of the plurality of buildings; and
electronically transmitting the electronic representation of the coordinated evacuation plan to one or more of a building occupant's device and an emergency service's device.
